(19) United States
(12) Patent Application Publication
(10) Pub. No.: US 2005/0261994 A1
(43) Pub. Date: Nov. 24, 2005

(54) Systems and methods for inserting active sale listings as advertisements into a pending buyer presentation

(75) Inventor: Tabbatha Lawe, Chapel Hill, NC (US)

Correspondence Address: ALUN L. PALMER, PATENT AGENT, 4300 PINEY CHURCH ROAD, WALDORF, MD, 20602, US

(73) Assignee: MyStoreCredit, Inc., Chapel Hill, NC (US)

(21) Appl. No.: 11/108,774

(22) Filed: Apr. 19, 2005

Related U.S. Application Data
(60) Provisional application No. 60/563,308, filed on Apr. 19, 2004.

(51) Int. Cl. G06F 17/60

(52) U.S. Cl. 705/30

(57) ABSTRACT

A system and method for enabling sellers to have an automatically created advertising message placed into a pending presentation opportunity such as an email or web page targeted to a known buyer based on matching seller specific parameters to known buyer attributes. The system also creates a promotional offer to be inserted with each advertising message. A computer program matches the seller campaign to the pending presentation opportunity record. Then, a further computer program creates the eligible seller's advertising messages by polling their market venue for their then active listings and appending them to the pending presentation opportunity record. A further computer program on the system creates and assigns promotional offers to each seller advertising message by executing instructions predetermined by the seller. Once the messages and promotions are created, the system composes and posts the final presentation for access by the buyer.

### BACKGROUND OF THE INVENTION

1. Field of the Invention

This invention relates generally to systems and methods for a seller to automatically have his/her active sale listings or a specific listing inserted as advertisements into a pending outbound email or presented via a link from an email to an advertised listing search web-page based upon matching desired characteristics of the prior purchase of the buyer/recipient for the pending outbound email to a seller's parameters. To further stimulate buyer response, sellers can utilize the system to create and include unique predetermined promotional offers to the targeted buyers.

2. Background of the Invention

Merchants and sellers at auction market venues, referred to here as sellers, use email marketing as a form of communication to stimulate buyer responses. E-mail marketing is one of the lowest cost methods for direct marketing. The responses to an email marketing campaign can be read quickly and the cost to develop an email campaign is much lower than other forms of direct marketing so it has distinct advantages for a seller over other forms of marketing promotion.

Generally, sellers have greater success when sending promotional email messages to previous buyers as opposed to random lists of email addresses. Response rates to email messages also improve when certain elements of data about the buyer are known and considered during targeting.

Yet, many retailers, and particularly those on the web and those operating auctions or store fronts at market venue sites often do not retain or have access to enough significant buyer knowledge or have access to enough volume of buyers to execute compelling email marketing campaigns.

Moreover, better success from an email campaign is usually associated with emails that have compelling content for the recipient. The email must contain a message or content that the recipient feels is worth reviewing or that person will simply delete the email considering it to be “junk mail.” Generally, compelling content includes targeted discount promotional offers or relevant editorial content.

Even if a seller has direct knowledge of a buyer's purchase history and has the buyer's opt-in permission to send email marketing messages with compelling messages and the seller has the technology available to efficiently execute an email marketing campaign, an individual seller often does not have enough volume of targeted buyers to warrant the time and effort required to create a unique outbound email marketing campaign.

Any opportunity for a seller to promote her listings directly to buyers will likely also benefit the market venue where the seller offers items for sale. Most market venue sites are “destination” sites. That is, a buyer generally has to proactively go to a specific market site like eBay.com to search for a desired item. In this way, the market venue is generally constrained by proactive buyer searches. The market venue site needs a vehicle to promote offers to buyers that might not otherwise come to search the site for the item. Thus, the market venue site would benefit dramatically if it could proactively promote seller listings to buyers during presentation opportunities in addition to promotion during the buyer's search at the web site.

To successfully conclude a sale, a seller on an auction venue often faces a difficult matching problem. The seller has to both match a) the right product to the targeted buyers; and b) match the time their item is promoted or available via auction to the buyer's purchase intention time to ensure a sale is closed. This requires the dynamic creation of offers that are actively being auctioned within the timeframe the email will be delivered. In an auction environment, pre-determined offers which are not dynamically created are difficult if not impossible to create to efficiently build success in an email campaign. The listing must be active when the email is sent out. If the listing is not active the email recipient will not be able to purchase it. If the listing has expired, the email recipient will not be able to purchase it either. The most feasible way to boost email marketing efficiency for auction sellers is by dynamically polling and capturing current auction listings for inclusion in a marketing email based on pre-determined targeting criteria.

Any combination of mismatching the wrong products listed in an email and/or mismatching the time a listing is active with the timing of email sent to the buyer will generally result in no sale for the seller and an inefficient use of email marketing to drive buyer activity.

This timing and matching problem is further exasperated by a lack of available buyer email opportunities. At any given time, a single seller will generally have a limited number of their own buyers to send promotional emails. Thus, when a seller has a product available to sell, the pool of potential buyers to target and who may want that product is generally constrained to the seller's own in house list of buyers who have opted in to receive emails from the seller. This lack of a broad base of buyers to target further reduces likely success for seller email marketing. Emails are excellent tools to link to an advertised auction listing or, if there are many promotional advertised listing, an email is a perfect vehicle to deliver a link to a more extensive web-page of many advertised auction listings.

In summary, sellers and market venues are interested in promoting listings or links to listings in emails where they can target their messages to a broad set of buyers based on matching data known about a buyer to data elements viewed as important by the seller within the window of a specific active listing.

### OBJECTS AND ADVANTAGES

Accordingly, several objects and advantages of my invention are providing market venue sites and any number of independent sellers the ability to promote their currently active sale items at auction market venues, referred to as listings in, or through, a pending buyer specific email based on known buyer attributes. Sellers utilize the system to have their active sale listings automatically added to a pending email to a known buyer when the known buyer has demonstrated the characteristics pre-selected by the seller. Alternatively, the targeted buyer's email can contain a link to an advertised listing search web-page for presenting a large volume of targeted offers.

Moreover, to further enhance the acceptability of the email offer, the system allows a seller to predefine a promotional offer to be included with the active listing included in the email. For instance, the promotional offer made to the targeted buyer may be a unique store credit which can be applied to a purchase of the listing being promoted or it can be a percentage rebate for first time buyers.

The invention allows a seller to predefine the targeted type of buyer to which the seller's listings should be promoted by identifying characteristics of a buyer which are then matched to a pending database of known buyers with pending presentation opportunities. The pending presentation opportunity may be an outbound email being sent to a known buyer. For example, a seller may establish one campaign that targets the inclusion of their then current listings by indirect link to a web-page or as a direct HTML link to their auction listing solely to any buyer-specific emails being sent to potential first-time buyerss who have made a prior purchase of an item on a market venue such as eBay.com, or another campaign can be established to match seller listings as advertisements in pending outbound emails for buyers who made purchases that had the word “Doll” in the purchased item title. The same seller may establish another campaign that targets inclusion of their active listings for any buyer specific email being sent to a buyer who made a prior purchase in the toy category, for at least $15.00 within the last 120 days. Sellers can establish any number of campaigns based on a single or combination of known buyer purchase data elements which may include, but are not limited to key words in the title of the item purchased, price point, date of purchase, category of purchase, geographic location of the buyer, etc. The market venue can provide the promotional opportunity at the time a seller lists the sale. Thus, if a buyer opportunity is available, the seller's listing(s) can be automatically added to the buyer's email.

A participating seller may also include a promotional offer to further stimulate buyer response. For instance, the promotional offer may be the rebate of a store credit amount tied to the sale of the promoted active listing. The store credit amount is an amount the seller will rebate to the buyer if the buyer purchases the promoted active listing from the seller. The store credit amount provides incentive for the buyer to open and read the delivered email and is only available when a purchase is concluded with the targeted buyer's ID. The inclusion of the store credit also creates an incentive for the buyer to respond to the email with a purchase.

### SUMMARY OF THE INVENTION

The preferred embodiment of the present invention provides systems and methods for enabling a seller to receive automatic placement of her marketing messages of active auction listings into a pending email targeted to a specific buyer based on matching known attributes of the buyer with the seller's requirements and including the seller's active listings or a seller specific listing as HTML links into the pending email or, if the volume of possible links is to high, by including the seller's active listings as HTML links on an advertised listing search web-page linked to from within the buyer's pending email. As a further enhancement to stimulate buyer response, the seller can also pre-establish promotional offers for the buyer which will be generated with each active listing promoted.

This system and method is comprised of a database of individual records of pending buyer specific email opportunities. Each opportunity record includes fields for the date the pending buyer specific email is scheduled to be sent to the buyer, the buyer's email address, the buyer's market venue id, the source related to the buyer email, and information about the buyer's past purchase transaction, demographics or interests which may include, but is not limited to, history of item or items purchased including prior seller IDs, date and time of purchase for each item, purchase price associated with each item, a product category identifier for each item purchased or a product category related to the source of the email, the title of each item purchased, the market venue from where each item was purchased, etc. Additional fields may identify the sex, age or location of the buyer. Any combination of such fields establishes one pending buyer specific email opportunity record.

In the preferred embodiment of the invention, the source of the pending email record can be any number of sources. One source is expected to be pending emails sourced from other individual sellers. The source individual seller may have any number of pending email records they expect to send out to their individual buyers. For instance, when the source seller sends an invoice to a buyer at the close of a sale, or causes an email to be sent to the buyer updating the buyer with any store credit information, or when notifying the buyer of shipment, etc., such expected emails can be the a source for the system's pending email opportunities.

Alternatively, the source could be any email sender such as a company sending an email newsletter to sports enthusiasts about the results of the latest game or an email sent to allergy sufferers about the daily pollen counts in their area. In this way, sellers who establish a campaign seeking eligibility into any email targeted to a potential buyer relating to allergies can become eligible for inclusion with the daily pollen count email being sent. Likewise, any seller who establishes a campaign for eligibility into any email targeted to sports enthusiasts can become eligible for inclusion with the sports score update email being sent.

Yet another source of pending email opportunities is from a market venue which sends email to its base of known buyers or from email service providers such as Hotmail, Yahoo, Google, MSN.com, AOL or any such provider who provides an email service for a buyer.

The system and method is also comprised of a seller database which includes, but is not limited to, seller information including seller name, address, active/inactive status, billing information, as well the market venue the seller sells through and/or the web address of the seller's own store web site. In addition, each seller record in the seller database is tied to fields representing any number of unique seller campaigns. Each unique seller campaign is defined after the seller updates fields with values determined by the seller during a campaign creation process to form a unique seller campaign. Campaigns preferably include predetermined promotional offers to include with any seller active listing subsequently promoted.

The system and method further includes a computer program which allows registered sellers the ability to create a campaign by entering the values of their choice into unique campaign fields identified in the seller's database record. Combinations of unique values entered by the seller create a unique campaign for that seller and are appended to the seller's record. Further, the market venue can capture a seller campaign during the item listing process by presenting the seller with various options for targeted criteria that promote the seller's new listing to specific types of buyers.

A seller may also establish a promotional offer they will provide to any buyer who makes a subsequent purchase with them directly tied to the pending email received using the system and method. In the preferred embodiment of the invention, this promotional offer is intended to be a [symbol] specific email database. Alternatively, this presentation creation program can create the relevant portions of an email for the known buyer and send the created portion to the original source of the email opportunity so that the relevant portions can be incorporated into the final email for delivery. In this way, an email service provider such as Yahoo or AOL can insert the relevant portions into emails being sent to buyers on their system.

Prior to the expected sending of the pending buyer email, the email creation program executes instructions to capture the eligible seller's marketing messages to include in the pending email such as the seller's then active listings and any seller promotional offer to be included with each active listing. In the preferred embodiment of the invention, the email creation program polls the market venue associated with the eligible seller to gather item description titles for the eligible seller's then active listings from the seller's market venue and creates a rebate or store credit promotional offer for the item.

The email creation program appends the captured titles of the seller's active listings into the pending buyer specific email database record. Each listing title is recorded in the database as HTML links. Alternatively, a photo from the listing may also be included in the email to further promote the seller's item. In the preferred embodiment of the program, if there are more than one-hundred matching listings, the email creation program alternatively creates and appends an advertised listing search web-page link into the email in lieu of individual HTML links. This link, when clicked from within the email, opens a web-page which can then be navigated by the email recipient to show matching targeted listings. To confirm the buyer's ID and ensure proper matching to the seller's campaign, the linked page may include a request for the buyer to enter their unique market venue ID prior to the display of properly matched targeted listings.

Once all the eligible seller listings are captured and promotional offers created, the system composes the final buyer specific email or relevant portions thereof, by combining pre-existing text templates with the appropriate seller listings, any photo and any promotional offers into the appropriate spaces of the email to create a final buyer specific email.

When the final pending buyer specific email is completed, the email or relevant portions are sent directly by the email creation program to the email address of the known buyer or to the source of the buyer specific record for final delivery by the source as appropriate.

The final buyer specific email, when delivered and opened, will show the targeted buyer an array of advertising messages along with any associated promotional offer the seller might promote with the listing or a link to a web-page where the buyer can view the properly targeted advertised messages. In the preferred embodiment of the invention, each advertised message on the web page or in the email are represented as the title of the seller's then active listings from the seller's preferred market venue with or without a photo of the listing. The titles are presented in the email or on the web pages as HTML links to the web address of the seller's listing at their preferred market venue or store web site. The promotional offer is a store credit amount which becomes available when the buyer purchases the store credit amount's associated listing.

When reading the email, the buyer can click on the web page link or any of the individual marketing messages within the email. This buyer action causes the buyer's web browser to open to a web address associated with an advertised listing search web-page from within the system or the selling page for that seller's listing at the appropriate market venue. If the advertised listing page is shown, buyers can search for specific listings and can click on any of the marketing messages in the advertised listing search web-page to view listings from matching seller campaigns. This buyer action causes the buyer's web browser to open to a web address associated with the selling page for that seller's matching listing at the appropriate market venue Once at the selling page, the buyer can choose to make a bid for that particular seller listing.

The aforementioned summary is intended to represent one potential use of the invention.

### BRIEF DESCRIPTION OF THE DRAWINGS

These and other features and advantages of the invention will now be described with reference to the drawings of certain preferred embodiments, which are intended to illustrate and not to limit the invention, and in which:

FIGS. 1A-1B are high-level architectural drawings illustrating the primary components of a marketing system for inserting active sale listings as advertisements into a pending buyer email.

FIG. 2 is a block flow diagram illustrating a high-level method in accordance with the invention.

FIG. 3 is a diagram of information for a seller account record for use with one embodiment of the present invention

FIGS. 4A-4B are screen displays of the seller registration on-line form which is completed by the seller to create a seller database record.

FIGS. 5A-5C are screen displays of the unique campaign creations form which is completed by the seller.

FIG. 6 is a high-level architectural drawing illustrating the input forms for creating a seller campaign.

FIG. 7 is a block flow diagram illustrating the matching and ranking of eligible seller campaigns to a pending buyer presentation opportunity.

FIG. 8 is a block flow diagram illustrating the creation of the final email and the final web page for the known buyer.

FIGS. 9A-9B show a sample final buyer specific email with predefined text and appropriately placed listings and HTML link to the sample buyer specific web page.

FIG. 10 is a screen display of a sample market venue “sell item” added features page showing the seller campaign creation inputs available during the item listing process.

FIG. 11 is a diagram of information for a pending presentation opportunity record for use with one embodiment of the present invention.

FIGS. 12A-12C show a sample buyer specific final web page showing all appropriately placed eligible created messages with store credit offers.

FIG. 13 is a sample market venue source web page for a specific buyer with predefined text and link to the specific buyer's final web page presentation.

FIGS. 14A-14B are sample final buyer specific emails with predefined text and an appropriately placed link used when many created messages would clutter the email and which link opens a web-page with categories for browsing by the email recipient.

FIGS. 15A-15B are alternative sample buyer specific presentation web-pages linked from sent emails where a buyer can browse, or browse only after confirming his/her market venue buyer ID, all appropriately matching advertised listings from sellers.

### DETAILED DESCRIPTION OF THE PREFERRED EMBODIMENT

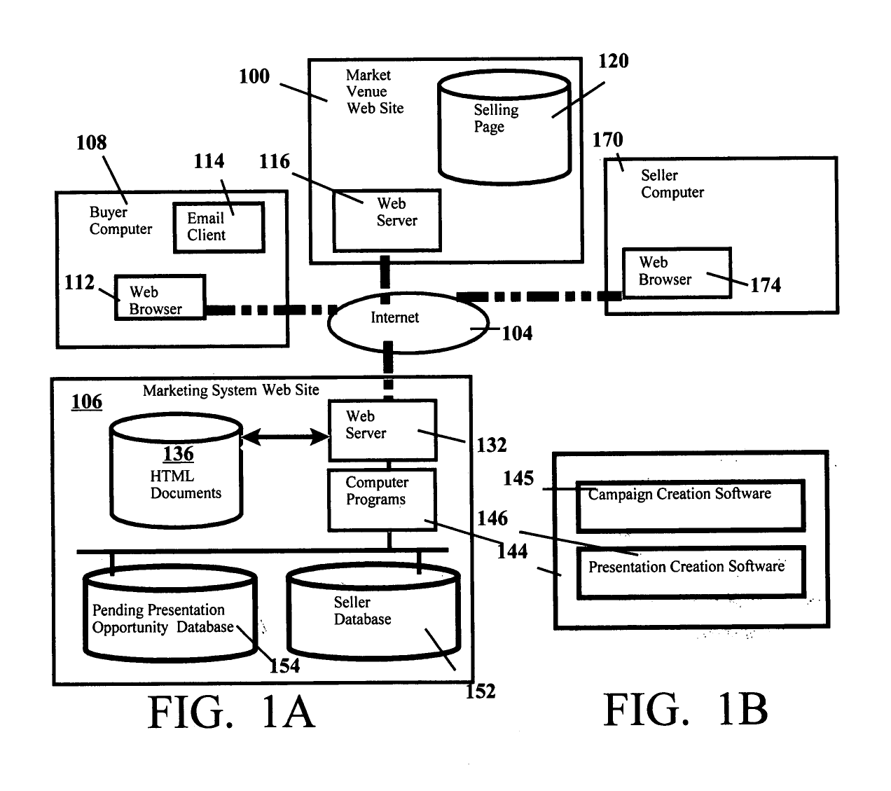

FIG. 1A is a high-level architectural drawing illustrating the primary components of a marketing system for inserting active sale listings as advertisements into a pending buyer email that operates in accordance with the present invention The marketing system includes a buyer computer 108, a market venue web site 100, a seller computer 170 and an marketing system web site 106, all of which are linked together by the Internet 104.

The buyer computer 108 may be any type of computing device that allows the buyer to receive and respond to emails 114 and interactively browse Web sites via a Web browser 112. For example, the buyer computer 108 may be a personal computer (PC) that runs the Windows NT operating system and Netscape Navigator and which can access the Yahoo Mail email service at Yahoo.com.

The preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The market venue web site 100 is a web site such as eBay.com, Amazon.com or Yahoo.com, which provides various functionality for allowing sellers to post listings for sale and for buyers to make offers to purchase said listings via a highest bid or a fixed price buying method over the Internet using their Web browser. Typically, the market venue web site 100 will be operated by a business entity that handles marketing functions to attract both buyer and seller to its site. The market venue web site 100 handles technical tasks to facilitate posting listings for sale, subsequent transaction processing including bid recording and final winning bid determination, reporting associated with the sale of almost anything between a buyer and seller and the presentation of a seller's web selling page 120 to a buyer. The market venue web site uses a web server 116 to send information as HTML web page displays, HTTP files, and emails to various entities, including the buyer computer 108, the seller computer 170, and the marketing system 106, over the internet 104 as is required to conduct appropriate transactions with each party.

The marketing system web site 106 advantageously includes a web server 132, HTML documents 136, multiple databases 152 and 154 and multiple computer software programs 144 (FIG. 1B)

The seller computer 170 may be any type of computing device that allows the seller to interactively browse Web sites via a Web browser 174. For example, the seller computer 170 may be a personal computer (PC) that runs the Windows 2000 operating system running Internet Explorer.

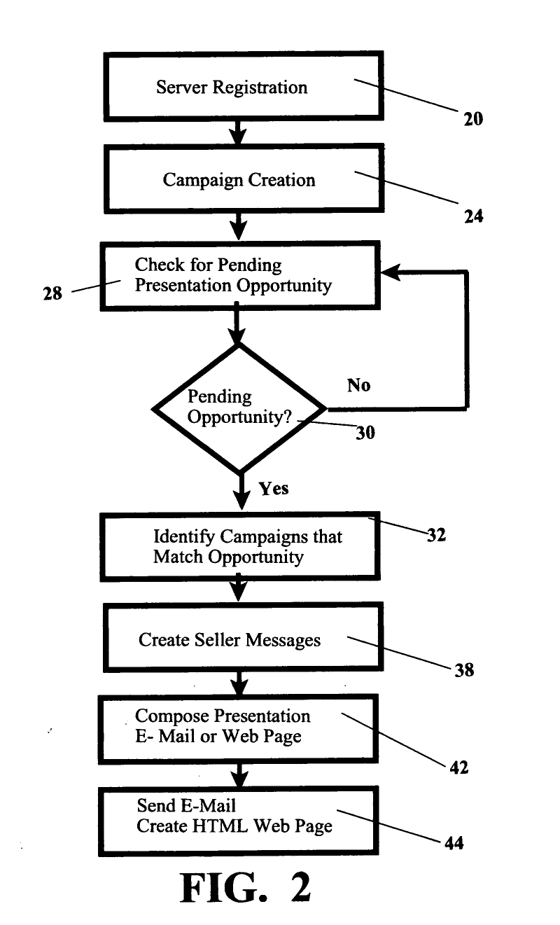

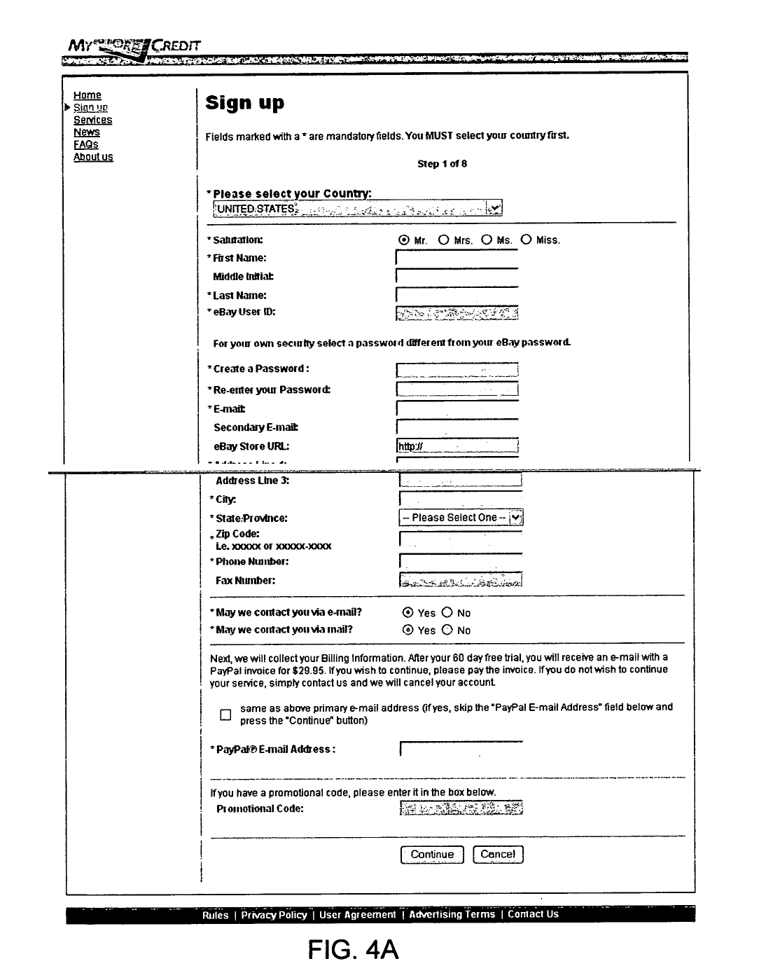

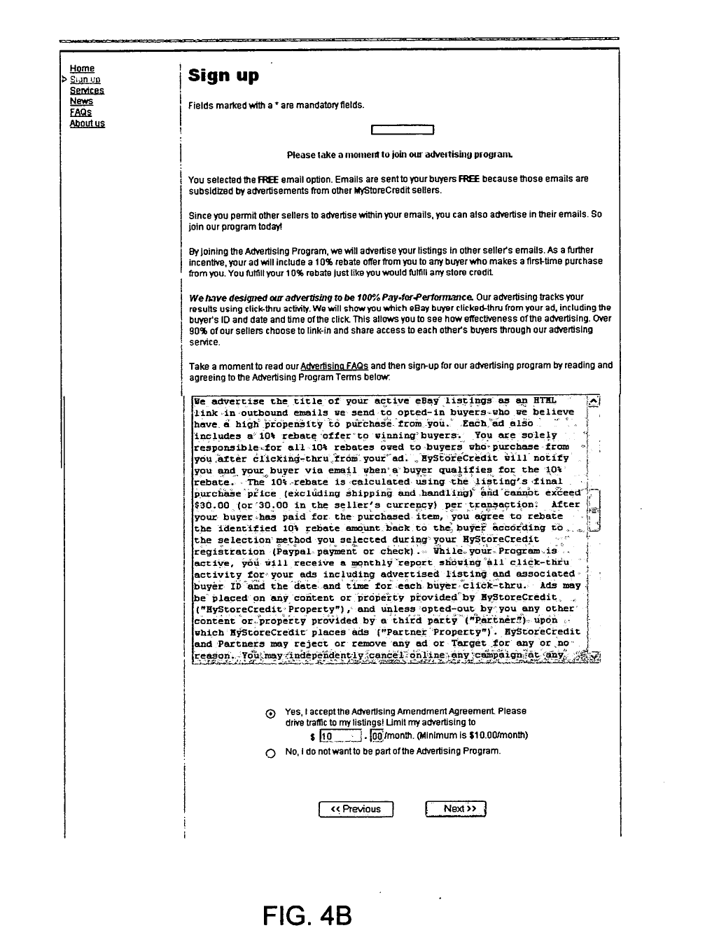

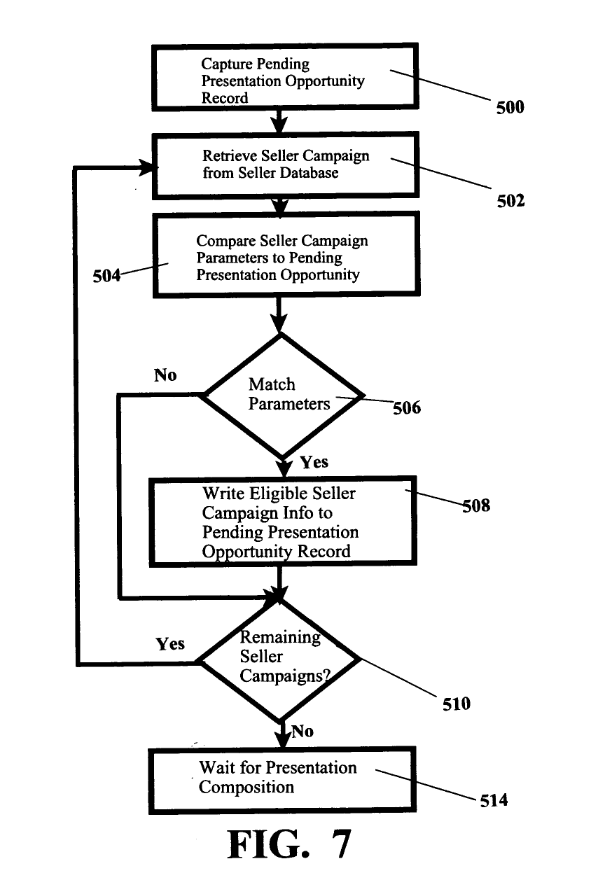

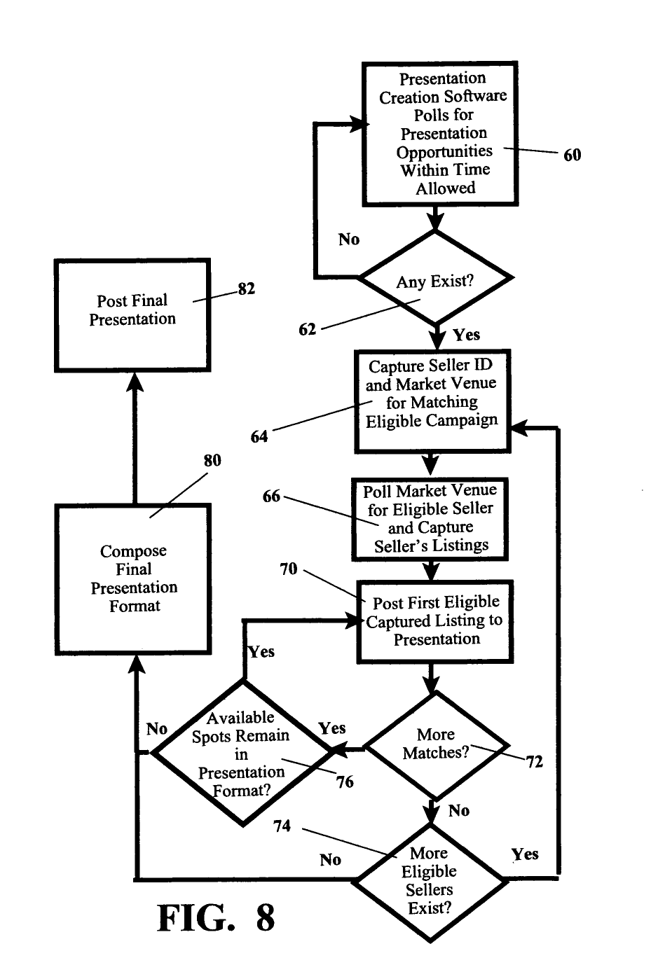

FIG. 2 is a general flow diagram of the method of this invention. Referring to this figure, the invention provides sellers with a mechanism to register for the marketing system. This activity is reflected as step 20 as detailed in the general flow diagram in FIG. 2. One embodiment of the marketing seller registration image 136 is illustrated in FIG. 4A-4B. Once registered, sellers can create unique campaigns during the campaign creation step 24. The campaign creation, step 24, is further illustrated using an architectural drawing in FIG. 6. In one embodiment of the invention, every 24 hours, or some reasonable time flame ranging from continuously to seconds or minutes, the presentation creation software 146, checks to see if any pending buyer specific presentation opportunity exist with expected delivery times within the next 24 hours, or some reasonable time frame ranging from continuously to seconds or minutes, step 28. If, during step 30, the presentation creation software 146 determines that no pending presentation opportunity exists, it returns to step 28. If the presentation creation software 146 indicates a buyer specific presentation opportunity is expected within the time frame identified, the presentation creation software moves to step 32 and identifies all eligible campaigns. The system identifies seller records where campaign parameters match the pending buyer specific presentation opportunity at step 32. Step 32 is shown in more detail in FIG. 7. FIG. 7 depicts a general flow diagram of the identification of eligible seller campaigns to a pending buyer presentation opportunity.

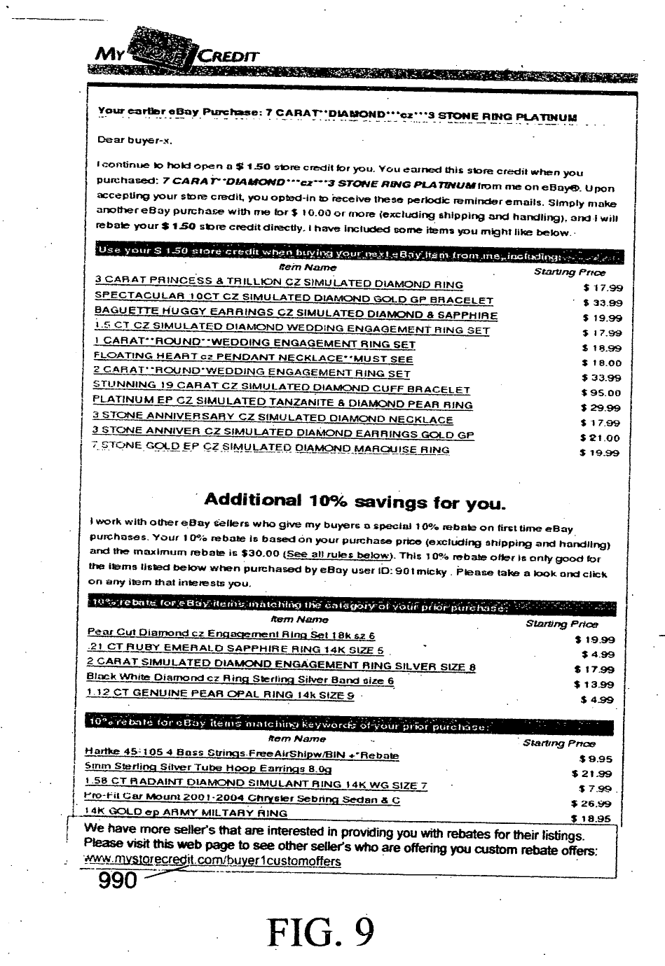

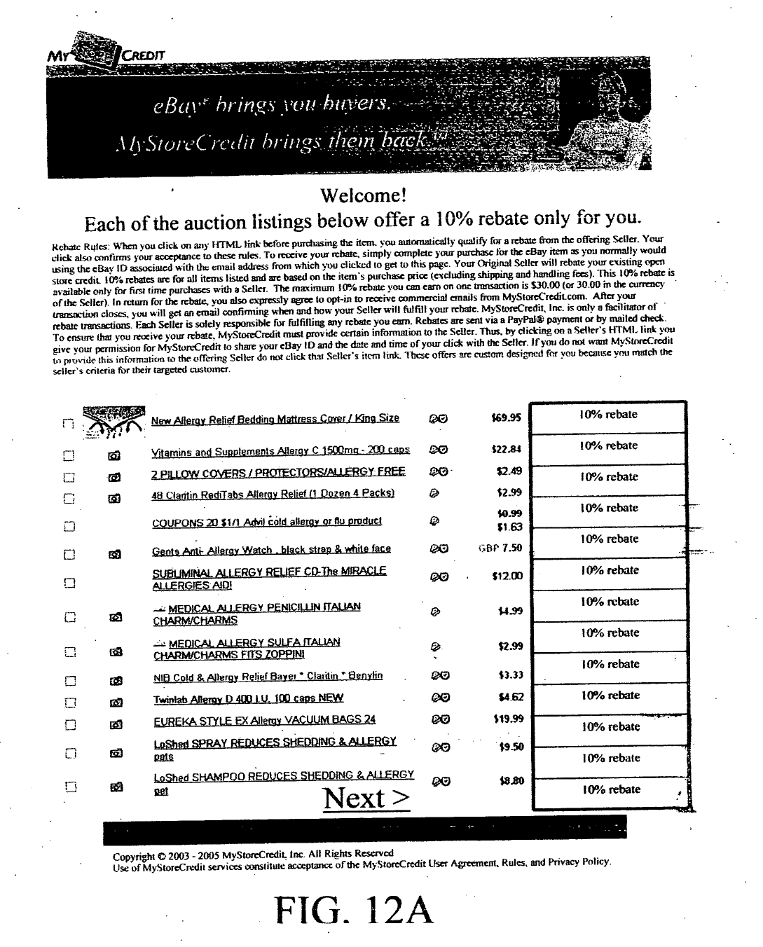

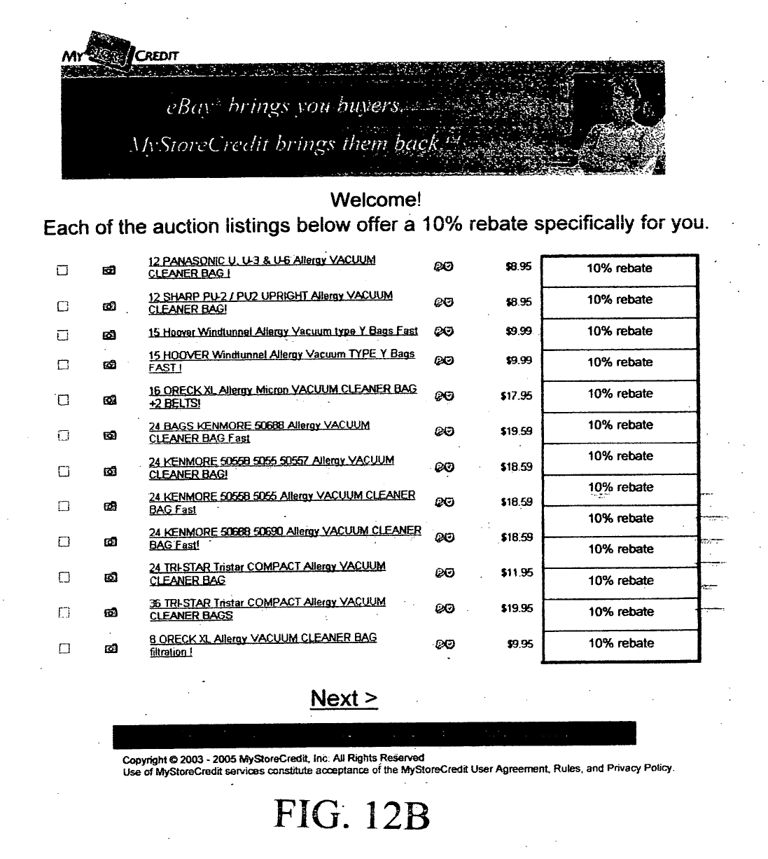

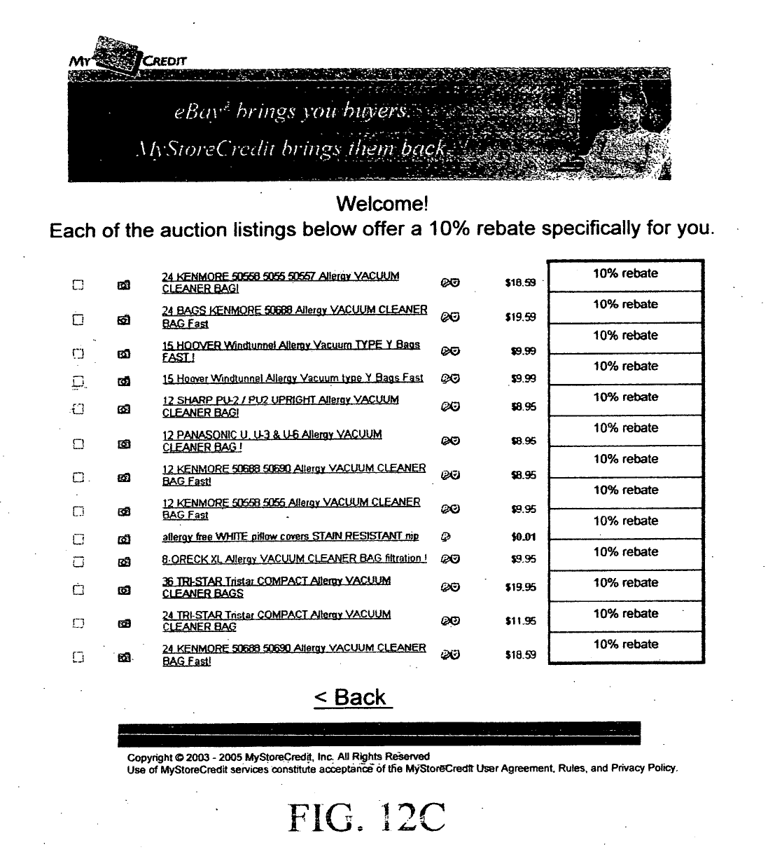

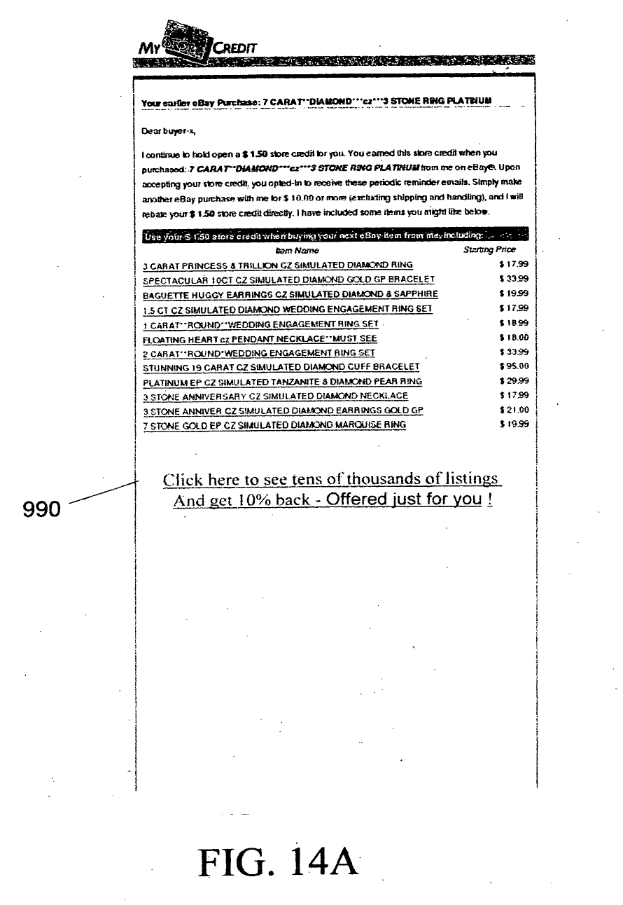

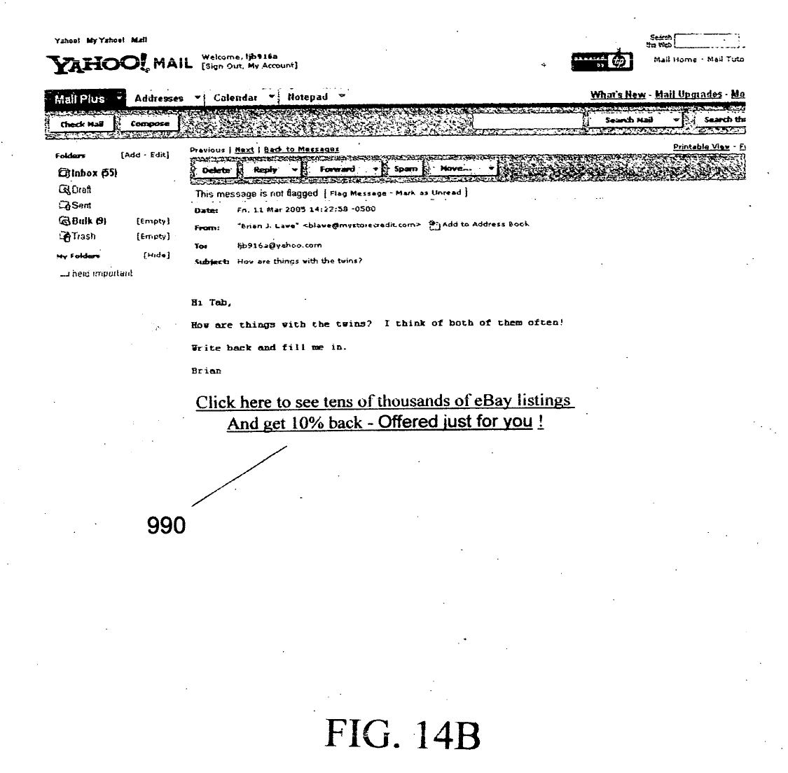

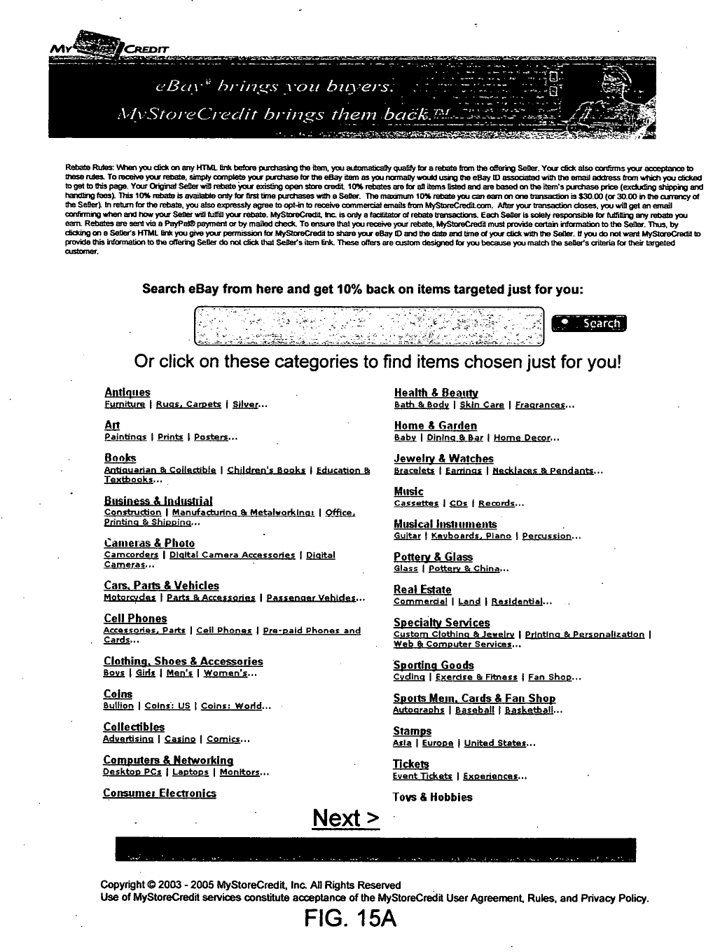

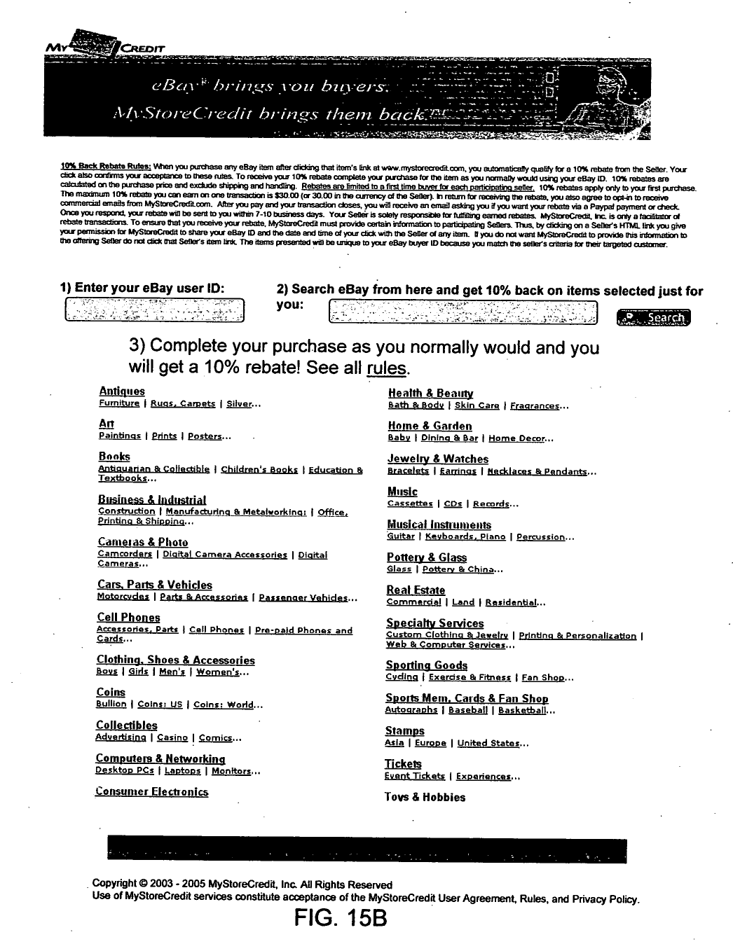

In step 38, the system creates eligible campaign messages by capturing active HTML links to listings on the market venue identified in the seller record of the eligible campaign. The system also creates any promotional offer based on the predetermined promotional offer entries defined in the seller database 152. The presentation opportunity is optimally an email (FIG. 9 or FIGS. 14A-14B) and/or final buyer specific web page (FIGS. 12A-12C or FIGS. 15A-15B). FIG. 8 depicts a general flow diagram of the creation of eligible seller messages with optional promotional offers. In step 42, the system composes the buyer specific presentation by combining preexisting text templates from within the presentation creation program 146 with the appropriate number of reserved seller advertising listings and store credit offers into the appropriate store credit section of the final pending buyer specific email or buyer specific web page. In Step 44, the email is sent or the web page is created and presented from the HTML documents 136.

FIG. 9 and FIGS. 14A-14B depict sample final buyer specific emails using pre-existing text combined with appropriate links or listings and associated store credit offers in a pending opportunity email. Referring to FIG. 9 and FIGS. 14A-14B, the final buyer specific email also includes an HTML link 990 to the buyer's final specific web page where the buyer can access all eligible listings FIGS. 12A-12C or FIGS. 15A-15B. Once received, the buyer can open the email using their email software 114 and click on any title of the active listings or the link to the final buyer specific web page. If the buyer clicks on any of the titles to the active listings, the buyer web browser 112 opens to a web address associated with that unique listing's selling page 120 on the market venue 100.

FIGS. 14A-14B depicts sample emails with only an advertised listing search link 990. If the buyer clicks on the Advertised Listing Search Link 990, the buyer specific web page HTML documents 136 on the marketing system 106 is presented on the buyer web browser 112 in the form of a buyer specific presentation web-page with a search function and categories browsable by the buyer which allow for efficient buyer perusal of multiple eligible created messages with store credit offers FIGS. 15A-15B. This embodiment minimizes the volume of listings included in the email while providing a link to a web-page where all available listings can be searched by the buyer. FIG. 15B demonstrates an alternate requiring the buyer to confirm his/her market venue ID prior to any display of advertised listings From a final buyer specific web page 136 the buyer can click on any of the listings on the buyer specific final web page 136 and the buyer's web browser 112 will open to a web address associated with that unique listings selling page 120 on the market venue 100. From the advertised listing selling page 120 at the market venue 100, the buyer can choose to make a bid or not.

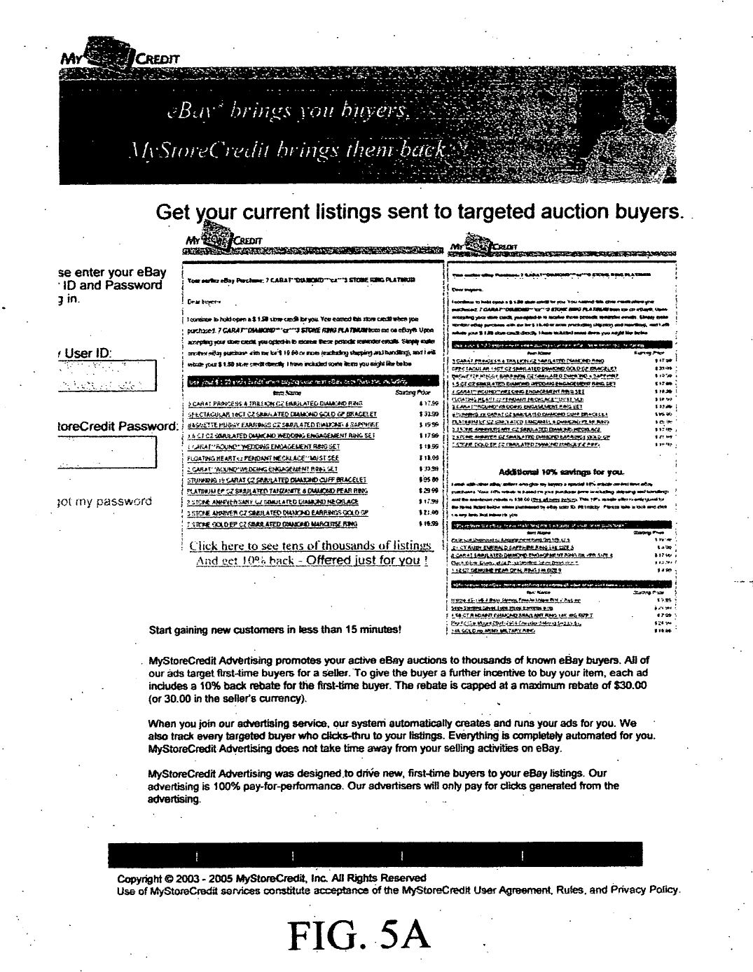

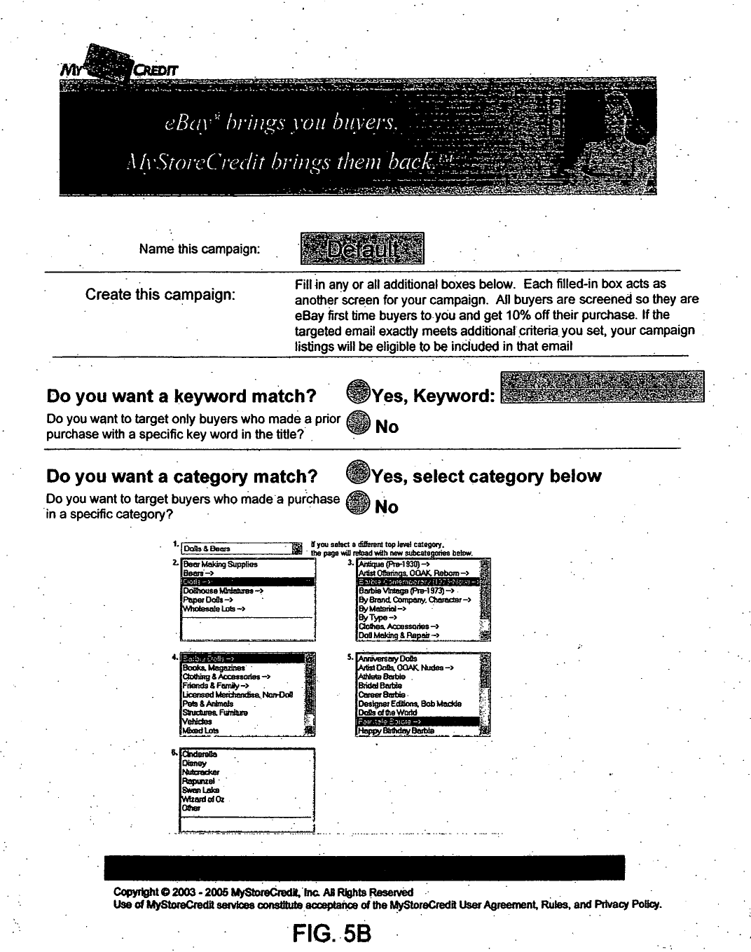

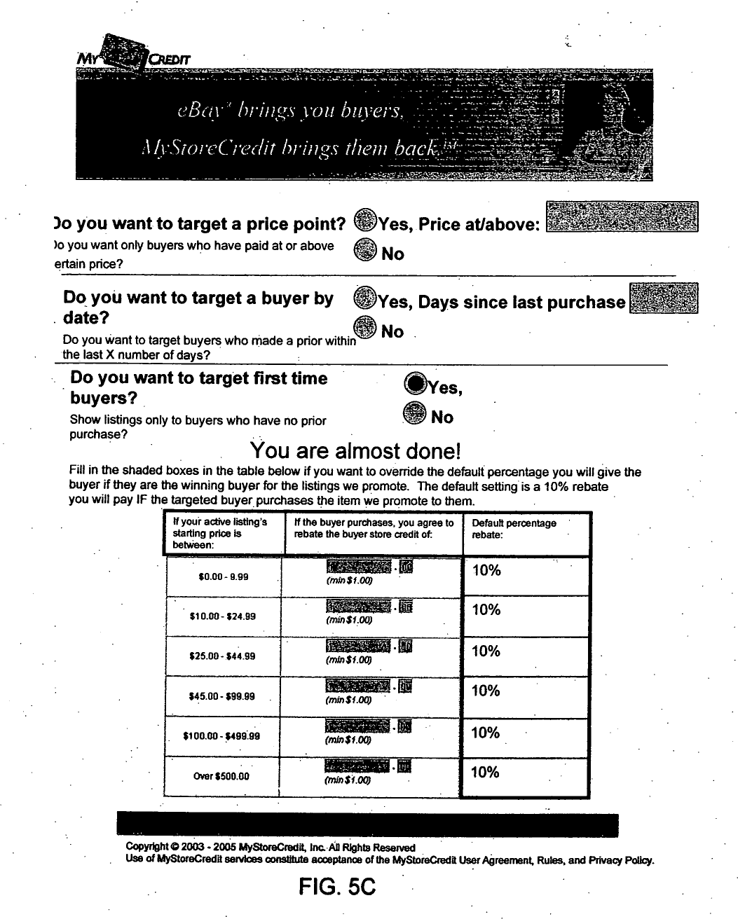

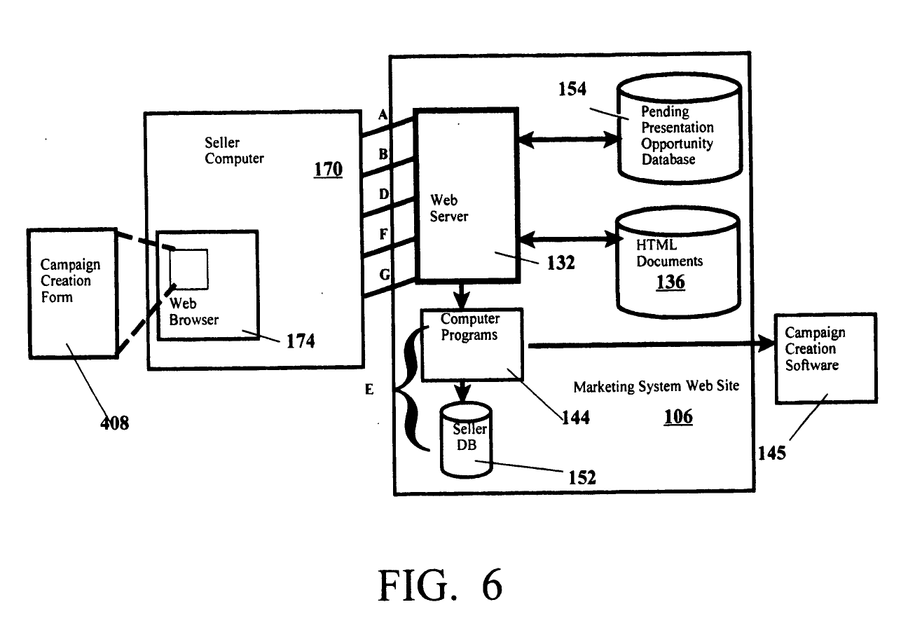

The campaign creation, step 24 of FIG. 2, is further illustrated using an architectural drawing in FIG. 6. Referring to FIG. 6, the system allows for a seller to access an on-line form (event A) from the marketing web site 106, which is sent to the seller computer 170 for viewing by the seller browser 174. A preferred embodiment of the campaign creation form 408 is illustrated in FIGS. 5A-5C. The seller receives the form (event B) and inputs data interacting with the form through a series of questions (event C). Once complete, the seller posts the message back (event D) to the marketing system web server 132. The marketing system server receives the message and form and the campaign creation software 145 creates a unique campaign database entry in the seller database 152 tied to the seller's user name (E). The campaign creation software 145 automatically displays a web page back to the seller computer 170 with confirmation of entries (event F). During the registration process, or anytime thereafter, the seller can return (event G) to the marketing system web site 106 and modify, cancel or create new campaigns tied to the seller's user ID in the seller database 152 (F).

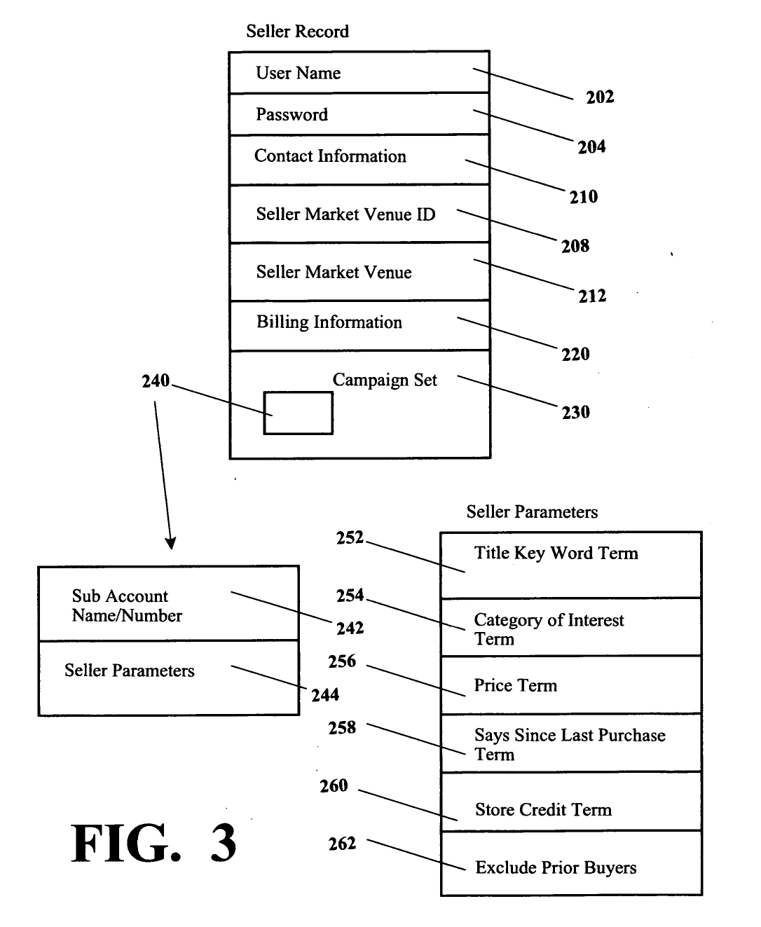

FIG. 3 is a diagram showing the types of information contained in a seller record 200 in the seller database 152. Each seller record 200 contains a user name 202 and a password 204, used to access the seller's account record. The account record also contains contact information 210, the setter's market venue ID 208 and the seller's preferred market venue 212. The account record 200 also contains billing information 220.

The campaign set 230 contains information which creates a seller campaign. This information is used to match a campaign to a buyer email opportunity. The campaign set 230 for each seller account 200 may have zero or more unique campaigns 240. A unique campaign 240 is comprised of a sub account name or number 242 which identifies the unique campaign. Each unique campaign further contains a set of unique seller parameters 244. Preferably each of the seller parameters 244 comprises at least one of the following information: title key word term 252, category of interest term 254, purchase price term 256, days since last purchase term 258 or a parameter for the exclusion of prior buyers 262. Further, seller unique campaigns 240 may include information showing at least one seller promotional store credit offer term 260 as a cash or percentage rebate offer.

The title key word term 252 is a free form text field which allows the seller to optionally enter any string of characters up to a maximum number, preferably less than 60, which, if present, must be presented in the same order in a matching pending buyer specific presentation opportunity record before a seller's unique campaign continues to be eligible for inclusion in the pending buyer specific presentation (exemplified in FIG. 9 and FIGS. 12A-12C). This process occurs during matching in step 32 of FIG. 2. If the title key word term 252 includes text and no match is made, the system will continue to evaluate the eligibility of the campaign using other parameters entered by the seller.

For example, if a unique campaign 240 shows the character string set “DOLL” in the title key word term 252, the prior purchase title 725 (FIG. 11) in the pending buyer specific presentation opportunity record 700 (FIG. 11) must also include “DOLL” to continue to make a seller's unique campaign 240 available for continued evaluation of inclusion in the eligible campaign set 740 of the pending presentation opportunity record 700. If the matching text “DOLL” is not identified in the pending presentation opportunity buyer's prior purchase title 725, the seller's campaign will not be made eligible for inclusion in that pending presentation opportunity based on this parameter set, but the system will continue to evaluate other parameters for a match.

If the seller leaves the title key word term 252 blank or does not wish to have the title key word term 252 used as a matching parameter, the system will continue to consider the default settings or other parameters of the seller's unique campaign 240 for further eligibility matching and will continue to evaluate the next unique campaign term against the presentation opportunity record 700 during step 32 of FIG. 2.

Thus, if the title key word term 252 is completed with a text string by the seller during the campaign creation (step 24, FIG. 2), the seller is setting parameters that will limit their eligibility to presentation opportunities for buyer's who have at least purchased items with the exact matching character string in the buyer's title of prior purchase. The system will continue with its matching evaluation for all the terms in the seller unique campaign 244.

The category of interest term 254 is a character field associated with a hierarchy of category definitions. The category definitions start with a root category and have sub-hierarchal categories that may be chosen by the seller during campaign creation. The seller can choose different hierarchy levels such that selecting a root category will encompass all sub-hierarchical categories where as selecting one of the sub-hierarchical categories will narrow the matching eligibility to only that branch and its subsequent sub-branches.

For example, one potential root category term might be identified by the character string “Dolls and Bears”. The “Dolls and Bears” root category encompasses a broad array of sub-categories. Within the “Dolls and Bears” root category, there are branch categories such as “Dolls.” The “Dolls” branch category has a further branch for “Barbie Contemporary (1973-Now).”

When a seller chooses a category, they are accepting the root and all the subsequent branch categories associated with that category. The hierarchy of the categories is shown to the seller within HTML documents 136 during the campaign creation process. During campaign creation, sellers can optionally set the category of interest term 254 to whatever category definition they choose in the options provided on the HTML documents 136. The category HTML documents 136 showing sample category definitions and hierarchies are advantageously shown in FIG. 5B.

When a seller selects a category term 254 during the campaign creation process, the system will evaluate, during step 32 of FIG. 2, if the category definition and its directly related sub-hierarchies includes the buyer category of purchase 732 (FIG. 11) or the category of interest 734 (FIG. 11) fields before the seller's campaign continues to be considered eligible for inclusion into the pending presentation opportunity record 700 (FIG. 11). If no match is made, the seller's campaign will not be made eligible for inclusion in that pending presentation opportunity based on this parameter set, but the system will continue to evaluate other parameters for a match

If the seller leaves the category of interest term 254 blank or does not wish to have the category of interest term 254 used as a matching parameter, the system will continue to consider the seller's unique campaign 240 available for further eligibility matching and will evaluate the next matching campaign term against the presentation opportunity record 700.

The purchase price term 256 is an optional numeric field representing the minimum price paid for a purchase by a buyer associated with any pending presentation opportunity. If the seller enters a minimum price point in the purchase price term 256, the purchase price 736 (FIG. 11) paid for an item associated with a pending buyer presentation opportunity record 700 (FIG. 11) must be at, or above, the seller's purchase price term 256 before the seller's unique campaign continues to be eligible for inclusion in the pending buyer specific presentation opportunity. The purchase price 736 and the purchase price term 256 are compared by the system during step 32 of FIG. 2. If the system determines that the purchase price 736 is below the purchase price term 256, thus no match is made, the seller's campaign will not be made eligible for inclusion in that pending presentation opportunity based on this parameter set, but the system will continue to evaluate other parameters for a match.

If the seller leaves the purchase price term 256 blank or does not wish to have the purchase price term 256 used as a matching parameter, the system will continue to consider the seller's unique campaign 240 available for further eligibility matching and will evaluate the next matching campaign term against the presentation opportunity record 700 during step 32 of FIG. 2

The days since last purchase term 258 is an optional term identifying a maximum amount of days the seller identifies between the purchase date associated with a pending presentation opportunity buyer's last purchase as recorded in the date of purchase 730 to the expected date of presenting of the pending presentation 710 in the pending presentation opportunity record 700.

The Exclude Prior Buyer term 262 is an optional yes or no field representing the sellers intent to exclude prior buyers from receiving any advertised listings with promotional offers. If the seller indicates a yes in the exclude prior buyers term 262, the buyer's Prior Seller IDs field 727 (FIG. 11) must not contain the seller's ID in order to have the seller's items eligible for inclusion in the pending buyer specific presentation opportunity. The Prior Seller IDs 727 and the seller parameter indicating exclude prior buyers 262 are evaluated by the system during step 32 of FIG. 2. If the system determines that the buyer's Prior Seller ID field 727 includes the seller ID of the seller's campaign being evaluated and the parameter exclude prior buyers 262 is set to yes, the seller's campaign will not be made eligible for inclusion in that pending presentation opportunity based on this parameter set, but the system will continue to evaluate other parameters for a match.

During the matching in step 32 of FIG. 2, the system calculates the number of days between the expected date of presenting of the pending presentation 710 and the date of purchase 730 and compares this elapsed number of days to any seller entry in the days since last purchase term 258. If the elapsed days is less than or equal to the days since last purchase term 258 entered by the seller in the unique campaign record 244, the campaign becomes eligible for inclusion into the pending presentation opportunity record 700 (FIG. 11). If the days since last purchase term 258 is shorter than the elapsed time calculated or if the seller leaves the days since last purchase term 258 blank or if the seller does not wish to have the days since last purchase term 258 used as a matching parameter, the system will close the campaign as not eligible and continue to the next available seller campaign for evaluation unless other seller parameters 244 are available beyond those shown here for as examples of the preferred embodiment of the invention.

The aforementioned campaign terms are not meant to limit or require these matching terms within the scope of the invention. Additional terms may be added and fewer terms are acceptable and the terms identified herein are not meant to be restrictive.

The store credit offer amount term 260 is a numeric field optimally identified by as many as four spaces preceding a decimal point and two spaces following the decimal point. In the preferred embodiment of the invention, this field represents the store credit amount in the form of a percentage back but can alternatively be dollars and cents that a seller will offer to a buyer who purchase the seller's eligible listing shown as messages in the final presentation (FIGS. 9, 12A-12C, 14A-14B, or 15A-15B).

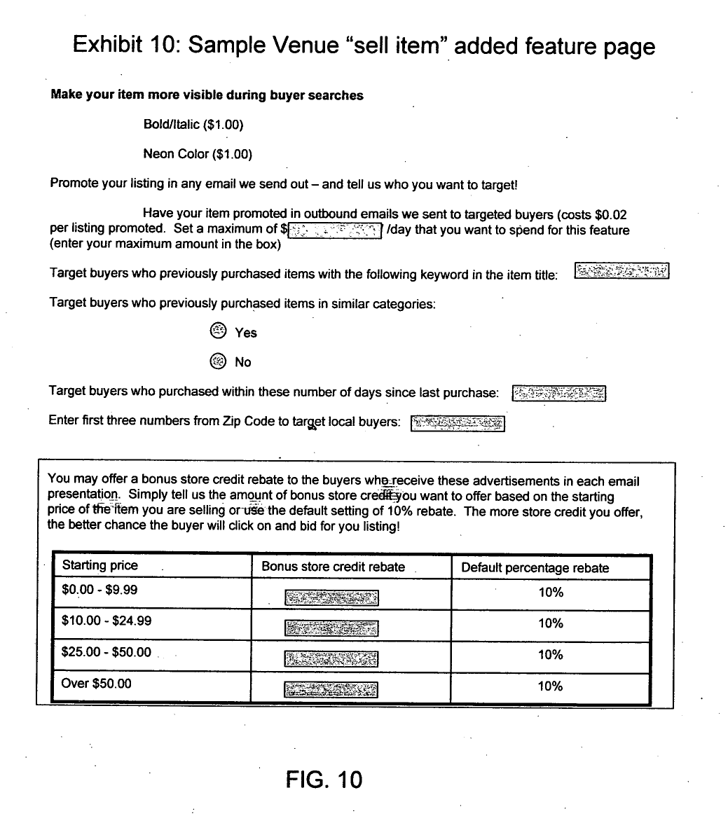

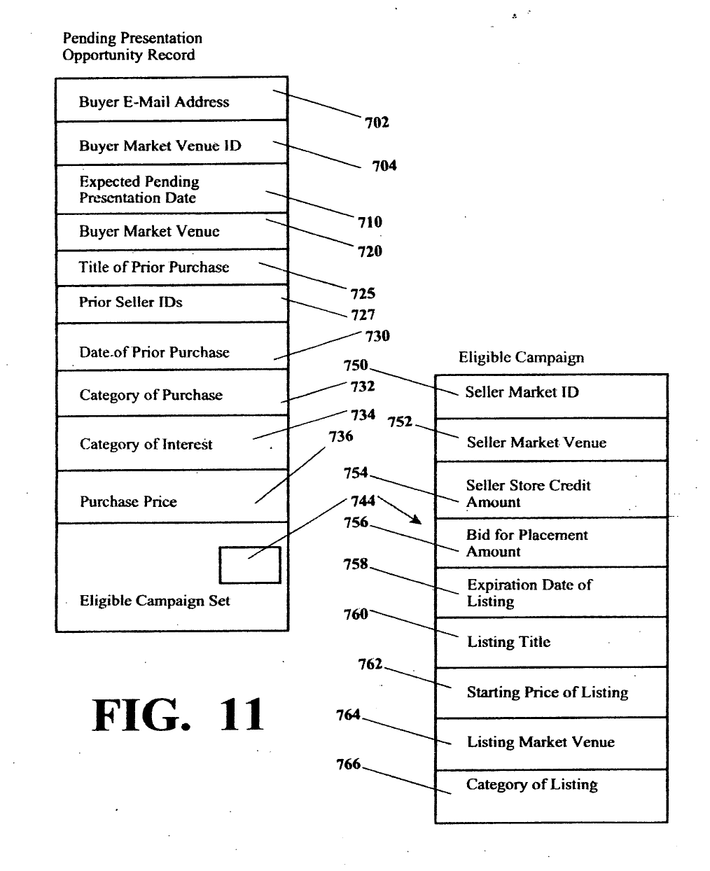

FIG. 10 is a sample of a market venue's “sell item” added features page. This is an alternative way that a seller can create their campaign. The campaign for the specific listing is created by the seller completing fields found on the form. By completing the fields during the item listing process for the market venue, the seller is indicating that the specific item being listed should be included in any presentation opportunity that matches the parameters entered by the seller in FIG. 10.

FIG. 11 is a diagram showing the types of information contained in a pending presentation opportunity record 700 in the pending presentation opportunity database 154. As has been mentioned, the elements of the seller unique campaign 244 within a seller record 200 are compared to the pending presentation opportunity record 700 during step 32 of FIG. 2.

Each pending presentation opportunity record 700 contains a buyer email address 702 and an expected date for presenting pending presentation 710. In addition, each pending presentation opportunity record 700 may contain the following as it relates to the buyer identified in the pending presentation opportunity: the buyer's market venue ID 704, buyer's market venue 720, title of prior purchase 725, date of prior purchase 730, category of purchase 732, category of interest 734, purchase price 736, source identifier 738 and cumulative bid for placement share amount 728 and prior seller IDs 727.

The buyer email address 702 is an alphanumeric character set of as many as 100 spaces which describe the email address of the buyer who is targeted for the pending presentation. The expected date of presenting pending presentation 710 is a date field representing the date the pending presentation is expected to be made to the buyer. In the case of email presentation dates, the expected date of presenting pending presentation 710 is the date the email is expected to be delivered to the buyer: If the pending presentation record 700 is associated with a final web page (FIGS. 12A-12C) the date is expected to be the first possible date the buyer could potentially be presented with an HTML link 990 relating to the buyer specific final web page (FIGS. 12A-12C). Alternatively, if the buyer clicks on a link from an email (FIG. 14B) and arrives at a linked presentation web page (FIG. 15B), the buyer is asked to confirm his/her market venue ID before the system evaluates matching and presenting seller advertised listings.

The expected presentation date for pending emails is in the form MM/DD/YYYY, where MM is equal to the numeric month, DD is equal to the numeric day of the month, and YYYY is equal to the calendar year. The expected presentation date for a linked presentation web page (FIG. 15B) requiring confirmation of the buyer ID can be immediate. The buyer's market venue ID 704 is the unique ID the buyer uses at the market venue. The buyer market venue ID 704 is an alphanumeric character set of as many as 100 spaces. The buyer's market venue 720 is an alphanumeric character set of as many as 100 spaces which describes the web address of the market venue 100 where the buyer ID is used. For instance, the buyer's market venue 720 can identify ebay.com, amazon.com or yahoo.com.

The title of purchase 725 in the pending email record is an alphanumeric character set that may contain the title of the past purchase of the buyer. Prior seller IDs 727 is an alphanumeric character set listing all prior seller IDs from whom the buyer has purchased. The date of prior purchase 730 represents the date the buyer's last known purchase, if any, in the form MM/DD/YYYY.

The category of purchase 732 is a character field associated with the category identifier for the buyer's purchase. The category of interest 734 is a character field describing an appropriate category that would be associated with the item purchased by the buyer. In both cases, the category definitions start with a root category and have sub-hierarchal categories that may be chosen by the source of the pending presentation opportunity record 700 such that specific hierarchy levels are selected that best associate with the item purchased by the buyer.

The category of interest 734 is optimally associated with a buyer pending presentation opportunity record 700 received from a source which has no prior buyer purchase data. For instance, if the source of a pending presentation opportunity record 700 is an allergy service with a web page, that allergy service could submit the buyer specific pending presentation opportunity record 700 to the pending presentation opportunity database 154 and indicate “Allergy” as the category of interest 734 without providing any further purchase history for the buyer in the record. Thus, when the buyer logs-in to the allergy service web site, the buyer will be presented an HTML link 990 and associated text that would invite the buyer to click on the HTML link 990 to be taken to the final buyer specific web page (FIGS. 12A-12C) where the buyer would be presented with any created messages for seller's who created campaigns that had “allergy” identified as the category of interest 734.

Thus, either the category of purchase 732 or the category of interest 734 can be used by the system to determine a match to a seller campaign during step 32, of FIG. 2. The purchase price 736 is a numeric field representing as many as four spaces for dollars and two spaces for cents. This field represents the purchase price for a prior purchase of the buyer. The source identifier code 738 is an alphanumeric character set of as many as 100 characters. The source identifier code 738 represents the source of the pending presentation opportunity record 700.

In the preferred embodiment of the invention, the source of the pending email record can be any number of sources. One source is expected to be pending emails sourced from other individual sellers. The source individual seller may have any number of pending email records that are expected to be sent out to individual buyers. For instance, when the source seller sends an invoice to a buyer at the close of a sale, or causes an email to be sent to the buyer updating the buyer with any store credit information, or when notifying the buyer of shipment, etc., such expected emails can be the a source for the system's pending email opportunities.

Alternatively, the source could be any email sender such as a company sending an email newsletter to sports enthusiasts about the results of the latest game or an email sent to allergy sufferers about the daily pollen counts in their area In this way, sellers who establish a campaign seeking eligibility into any email targeted to a potential buyer relating to allergies can become eligible for inclusion with the daily pollen count email being sent. Likewise, any seller who establishes a campaign for eligibility into any email targeted to sports enthusiasts can become eligible for inclusion with the sports score update email being sent.

Yet another source of pending email opportunities can be emails being sent to a buyer from the market venue such as updates on current bids, notification of won or lost bids, account status, etc, or from email service providers such as Hotmail, Yahoo, Google, MSN.com, AOL or any such provider who provides an email service for a buyer.

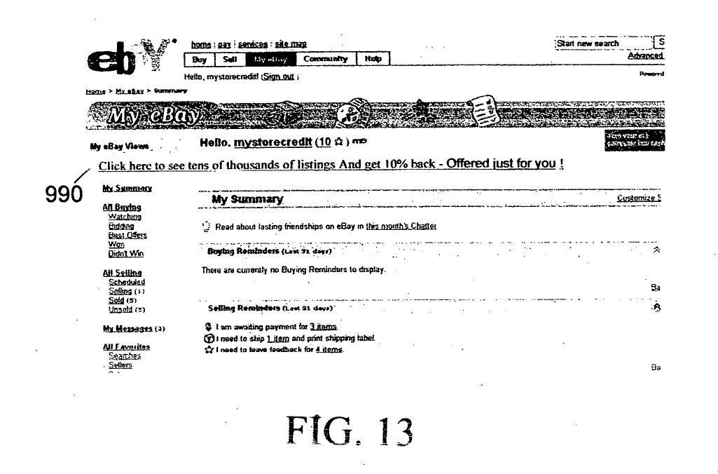

Another source of a pending presentation opportunity record 700 is expected to be any web site which requires a buyer to log in so that a pending opportunity can be matched for the identified buyer based on the buyer's market venue ID or the buyer's email address. Thus, web site sources could be interest specific web sites like those specific to sports or allergies, or a market venue itself. A market venue can establish a pending presentation opportunity which occurs daily in anticipation of a registered buyer signing-in to that market venue site. Thus, on a daily basis, the system will recognize a buyer specific presentation opportunity record 700 for a buyer who logs into the market venue and the record would indicate the source as the market venue. The system would create a buyer specific web page (FIGS. 12A-12C or 15A-15B). To access this presentation, the buyer might be presented with an HTML link 990 on the welcome page when they sign in to their market venue web site. FIG. 13 demonstrates how the HTML link 990 can be presented to the buyer upon their logging into the market venue site. Thus, when the pending buyer logs in to the market venue, the market venue will present the buyer with predefined text and the HTML link to the buyer specific final web page FIGS. 12A-12C. The buyer can click on the HTML link 990 from that displayed log-in welcome page and be taken to the final buyer specific web page (FIGS. 12A-12C or 15A-15B) showing the eligible seller's created marketing messages as HTML links. The buyer can than click on any of the created message HTML links and be transported back to that listings selling page 120 on the market venue's web site.

The presentation opportunity record 700 also contains an eligible campaign set 740. The eligible campaign set 740 contains information appended to the presentation opportunity record 700 after a match of the pending buyer presentation opportunity record 700 is made to any seller campaign 242. The eligible campaign set 740 for each pending presentation opportunity record 700 may have zero or more eligible campaigns 744. The system identifies and appends information for all eligible campaigns 744 during step 32, FIG. 2. Step 32 is shown in more detail in FIG. 7.

FIG. 7 is a block flow diagram illustrating the matching and ranking of eligible seller campaigns to a pending buyer email.

Referring to FIG. 7, step 500, the presentation creation software 1446 captures the open pending presentation opportunity record 700. In step 502, the first available unique seller parameters 244 are retrieved from the seller database 152. In step 504, the presentation creation software 146 compares the unique seller parameters 244 identified in the unique seller campaign record 240 to the known parameters in the pending presentation opportunity record 700 as detailed in previous pages. In step 506, for each term in the unique seller parameters 244, the system identifies if a match exists for the evaluated term. If so, the system moves to step 508.

If there is an exact match to the evaluated parameter the system moves to step 508 where the system copies selected elements from the seller's record 200 to the appropriate fields in the pending buyer presentation opportunity record 700 creating an eligible campaign 744 entry in the eligible campaign set 740.

The fields that are copied by the presentation creation software 1464 during step 508 (FIG. 7) from the seller record 200 to the pending presentation record 700 are as follows: Seller market ID term 208 (FIG. 3) copied to seller market ID 750 (FIG. 11); seller market venue term 212 (FIG. 3) copied to seller market venue term 752 (FIG. 11); seller store credit amount term 260 copied to seller store credit amount term 754. Multiple eligible campaign records 740 can be created for each pending presentation opportunity record 700. Subsequent fields are created during the presentation composition process discussed below.

Referring to FIG. 7, after the system copies the eligible seller campaign information to the pending presentation opportunity record 700, step 508, the system moves to step 510.

If an exact match is not made to any terms identified by the seller during step 506, the system moves to step 510 to determine if there are additional seller campaigns that have not yet been evaluated.

At step 510, the system evaluates if additional seller campaigns remain for evaluation. If so, the system returns to step 502. If not, the system moves to step 514 to await the start of the presentation composition step 42, FIG. 2. Step 42, FIG. 2 is shown in more detail in FIG. 8.

FIG. 8 is a general flow diagram of the pending presentation composition process which encompasses the creation of the seller advertising messages and the compilation of the email (FIGS. 9 or 14A-14B) and final buyer specific web page (FIGS. 12A-12C or 15A-15B). Referring to FIG. 8, in step 60 the presentation creation software 146 polls the pending presentation opportunity database 154 for all pending presentation opportunity records 700 with matching eligible campaigns which have scheduled delivery dates within the appropriate time frame, such as within 24 hours, by looking at the field labeled expected date of presenting pending presentation 710 in the pending presentation opportunity record 700. If so, as determined at step 62, the system moves to step 64 and calls the seller market ID 750 and market venue 752 of the first eligible seller in the eligible campaign set 740 of the pending presentation opportunity record 700.

At step 66, the system polls the market venue identified and captures the then active listings for the ranking seller under consideration. In the preferred embodiment of the invention, the system uses the market venue's application programming interface to send a call message over the internet 104 to the market venue. Upon receipt of the call message, the market venue returns information about the ranking seller's active listings to the system. The listing information is appended to the pending presentation opportunity record 700 under the eligible campaign 744. The captured listing information includes the listing title 760. The listing title 760 is recorded as an HTML link directly to the web address of the listing selling page 120 on the appropriate market venue. In addition, the captured listing information includes the expiration date of the listing 758, the starting price of the listing 762, the listing market venue 764 and the category of the listing 766.

At step 70, the system posts the seller's eligible captured listing into the appropriate spot for each of the presentation opportunities. The presentation creation software 146 recognizes a limited number of spots available for advertising listings. These spots are filled with seller messages depicted as HTML links with the appropriate store credit offers in each presentation opportunity format. The email presentation format (FIGS. 9 or 14A-14B) and the buyer specific web page presentation format (FIGS. 12A-12C or 15A-15B) have available spots under 100 and under 100,000,0000 respectively. If the email presentation will show more than 100 potential advertised listings, the email can be created to show only a link to a web-page as in FIGS. 14A-14B. Alternatively, in lieu of showing listings as in FIGS. 12A-12C, the web-page can first show sub-categories such as jewellery, electronics, dolls, etc., as depicted in FIGS. 15A-15B, such that a buyer can click a category to navigate to sub-set of specific advertised listings within that category. In this way, the buyer can more efficiently browse listings which the buyer is interested in, rather than scanning through many advertised item listings.

At step 72, the system evaluates if the current evaluated seller has additional eligible listings. If no, the system moves to step 74 to determine if more eligible sellers exist. If, at step 74 the system identifies more eligible sellers exist, the system returns to step 64 for the next eligible seller.

If at step 72, the system determines that the current evaluated seller has additional eligible listings, it moves to step 76 to determine if available spots in the email or web page remain. If yes, the system returns to step 70 to post the current evaluated seller's eligible listing into the next eligible reserved spot for each presentation format.

Next, the system moves to step 80 and composes each final presentation format. In the preferred embodiment of the invention, the final presentation format is an email (FIG. 9 or 14A-14B). Alternatively, the final presentation format can be a final buyer specific web page (FIGS. 12A-12C or 15A-15B). The email is composed by the presentation creation software 146 by combining predefined text from within the presentation creation software 146 with the HTML title links of the reserved eligible listings and any associated promotional store credit offer made by the seller. The final buyer specific web page is composed by the presentation creation software 146 by combining predefined text from with the presentation creation software 146 with the HTML title links of the eligible listings under each appropriate store credit section of the web page. At step 82, the system posts the final presentations. The posting of the email presentation includes the sending of the final email. The posting of the final buyer specific web page includes sending the final buyer specific web page formatting to the HTML documents 136 for subsequent accessing by the buyer web browser 112.

Alternatively, the system can send the compiled email or final buyer specific web page to any third-party for further processing or final presentation. For example, the system can send the final compiled email to an email service provider such as Yahoo, MSN, AOL or other such email service provider or to an allergy alert email service, a sports update email service, an auction management system, a stock email newsletter service, etc. The third-party email source can append the compiled email to their own information and deliver the final email, inclusive of the appended HTML titles or web page links with store credit offers (FIGS. 14A-14B, to the email address of the buyer. Likewise, the system can post the final buyer specific web page to a market venue. The market venue can then present the final buyer specific web page to the buyer from within the market venue web site 100.

It will be appreciated by those skilled in the art that numerous modifications and variations are possible, and that the invention may be practiced otherwise than as specifically described herein, without departing from the scope thereof.

1. A computer-implemented system to enable a seller using a computer network to cause a system generated advertising message showing an active auction listing to be placed into a presentation opportunity based on matching at least one seller determined parameter, comprising: a computer having stored therein:
a pending presentation opportunity database having at least one buyer account record for said at least one pending presentation opportunity, said at least one buyer account record comprising:
an expected presentation date of said at least one possible presentation opportunity to a buyer;
a seller database having at least one seller account record, said at least one seller account record comprising:
at least one seller campaign record comprising at least one seller determined campaign parameter;
a matching program for matching said at least one seller determined campaign parameter to at least one of said buyer account records in said pending presentation opportunity database to determine that said seller is an eligible seller;
a message creating program for generating said advertising message, comprising code to:
poll an identified market venue of said eligible seller to gather seller active listings as HTML links; and
create said advertising message by combining said active listings in an appropriate presentation with predefined text.

2. A computer-implemented system according to claim 1, wherein:
said advertising message comprises an email and a web page.

3. The computer-implemented system according to claim 1, further comprising:
a computer software program that creates and assigns a promotional offer for each said advertising message based on seller inputs.

4. An automated method performed by a computer-implemented marketing system for establishing, identifying, creating, and posting a marketing message in a pending opportunity presentation to a known buyer, the method comprising:
establishing a campaign for a seller based on parameters entered by said seller;
identifying an eligible seller by identifying a seller campaign that matches a pending presentation opportunity record based on at least one characteristic of said known buyer;
creating a marketing message by capturing said eligible seller's then active listings from a market venue;
posting said marketing message for presentation to said known buyer.

5. The method of claim 4, further comprising:
assigning a pre-determined promotional offer to said active listing.

6. An automated method performed by a computer-implemented marketing system for establishing, identifying, creating, and posting a marketing message in a pending opportunity presentation to a known buyer, the method comprising:
means for establishing a campaign for a seller based on parameters entered by the seller;
means for identifing an eligible seller by identifying a seller campaigns that matches a pending presentation opportunity record based on at least one characteristic of said known buyer;
means for creating a marketing message by capturing said eligible seller's then active listings from a market venue;
means for posting said marketing message for presentation to said known buyer.

7. The system of claim 6, further comprising:
means for assigning a predetermined promotional offer to said active listing.
